(19) United States
(12) Patent Application Publication
(10) Pub. No.: US 2013/0110932 A1
(43) Pub. Date: May 2, 2013

(54) AUTOMATED ACTION BUILDING FOR SOCIAL NETWORKING DATA CHANGES IN A CUSTOMER RELATIONSHIP MANAGEMENT (CRM)

(71) Applicant: SUGARCRM INC., Cupertino, CA (US)

(72) Inventors: Majed Itani, San Jose, CA (US); Rob Aagaard, Midvale, UT (US); Lila Tretikov, Los Gatos, CA (US); Clint Oram, San Mateo, CA (US)

(73) Assignee: SUGARCRM INC., Cupertino, CA (US)

(21) Appl. No.: 13/714,364

(22) Filed: Dec. 13, 2012

Related U.S. Application Data
(63) Continuation-in-part of application No. 13/019,295, filed on Feb. 1, 2011.

(51) Int. Cl. H04L 29/08

(52) U.S. Cl. CPC H04L 29/08072
USPC 709/204

(57) ABSTRACT

Embodiments of the present invention provide a method, system and computer program product for automated action building in a CRM system based upon social networking data changes detected in a social network. In an embodiment of the invention, a method for automated action building in a CRM system based upon social networking data changes detected in a social network is provided. The method includes registering different customers in a CRM application for social network monitoring and detecting an event for one of the registered different customers in a social networking system communicatively coupled to the CRM application over a computer communications network. The method additionally includes responding to the event by posting an action in the CRM application for the one of the registered different customers.

### CROSS-REFERENCE TO RELATED APPLICATIONS

This application is a Continuation-in-Part of U.S. application Ser. No. 13/019,295, filed on Feb. 1, 2011, now U.S. Pat. No. ______, which is incorporated herein by reference in its entirety.

### BACKGROUND OF THE INVENTION

1. Field of the Invention

The present invention relates to CRM and more particularly to integrating social networking data into a CRM application.

2. Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

The advent of the Internet has changed the changed the way in which end users approach CRM strategies because advances in technology have also changed consumer buying behavior specifically and vendor-customer interaction generally, especially the way in which businesses communicate with customers and collect and use data about those customers. More than the past, self-service channels such as the World Wide Web (“Web”) and more recently, the mobile computing world, have become the norm rather than the exception leading to easier ways in which to manage customer information electronically.

Social networking refers to the collective computing activities of different individuals for which different social relationships exist whether known or unknown to the different individuals. Social networks range from recreational Web sites in which different individuals register and provide personal data linking the individuals to one another according to specified relationships, to business relationship Web sites in which business leads and new business networking contacts are fostered. Social networks minimally provide a simplistic database driven application in which different end users are linked to one another according to specified relationships and through which communications therebetween are facilitated. More complex social networks mine contact data of different end users to prompt the end users with proposed new relationships. For many, the use of a social network is a broadcast outlet through which individuals and companies can publish events of interest and pertinent news items.

CRM applications provide invaluable programmatic assistance to end users seeking to maintain quality customer relationships. However, CRM applications generally support the maintenance of customer relationships through the organization of customer data provided by the end user. Yet, part of maintaining a quality customer relationship is to continuously track contemporaneous developments in the business of customers and their respective employees with the goal of engaging the customer at an optimal point in time for a successful interaction. Traditionally, this sort of “live” data is gathered manually by sales and marketing, or perhaps customer relationship employees and submitted to the CRM application for the organization. In some cases, live data can be obtained through the use of social networking Web sites by sales and marketing or customer relationship employees.

However with an increasing flow of data on such social networking Web sites, acquiring the relevant live data for a large number of customers and keying that data into a CRM application can be a daunting if not unlikely task. Further, simply submitting contemporaneous customer data determined from a social network site does not guarantee that the organization will act upon the acquired data.

### BRIEF SUMMARY OF THE INVENTION

Embodiments of the present invention address deficiencies of the art in respect to CRM integration of social networking data and provide a novel and non-obvious method, system and computer program product for automated action building in a CRM system based upon social networking data changes detected in a social network. In an embodiment of the invention, a method for automated action building in a CRM system based upon social networking data changes detected in a social network is provided. The method includes registering different customers in a CRM application for social network monitoring and detecting an event for one of the registered different customers in a social networking system communicatively coupled to the CRM application over a computer communications network. The method additionally includes responding to the event by posting an action in the CRM application for the one of the registered different customers.

In one aspect of the embodiment, the method optionally can include collecting news items for the registered different customers in different social networking systems and displaying news items for a specific one of the registered different customers responsive to displaying a profile of the specific one of the registered different customers in the CRM application. In another aspect of the embodiment, the method optionally can include collecting news items for the registered different customers in different social networking systems, rating the news items according to a relatedness between the registered different customers and the news items, and displaying only those news items for a specific one of the registered different customers of a threshold rating responsive to displaying a profile of the specific one of the registered different customers in the CRM application.

In another embodiment of the invention, a CRM data processing system is provided. The system includes a host computing system with memory and at least one processor and a CRM application executing in the memory of the host computing system and coupled to different social networking systems over a computer communications network. The system also includes a social network event response module coupled to the CRM application. The module includes program code that when executed in the memory of the host computing system is enabled to detect an event for one of different registered customers in one of the social networking systems, and to respond to the event by posting an action in the CRM application for the one of the different registered customers.

In one aspect of the embodiment, the event is a profile change of the customer indicating a new position with a new company. In another aspect of the embodiment, the event is a profile change of the customer indicating a newly hired employee for a particular position with the customer. In yet another aspect of the embodiment, the action is a task in the CRM application associated with the one of the registered customers. Finally, in event yet another aspect of the embodiment, the action is a meeting scheduled in the CRM application with the one of the registered customers.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for automated action building in a CRM system based upon social networking data changes detected in a social network;

FIG. 2 is a schematic illustration of a CRM data processing system configured for automated action building based upon social networking data changes detected in a social network; and,

FIG. 3 is a flow chart illustrating a process for automated action building in a CRM system based upon social networking data changes detected in a social network.

### DETAILED DESCRIPTION OF THE INVENTION

Embodiments of the invention provide for automated action building in a CRM system based upon object attribute changes detected in a social network. In accordance with an embodiment of the invention, a customer, whether a company or an individual, stored in a CRM system can be registered for social network data monitoring in a social network. Thereafter, a communicative link can be established between the CRM system and the social network and a data change can be detected in association with the customer. For example, where the customer is a company, a new contact assigned to a position in the company can be detected. As another example, where the customer is a contact, a new employer for the contact can be detected. In response to detecting the data change for the customer, a CRM action can be scheduled in the CRM system, such as creating a task in the CRM system to contact the customer in reference to the data change, or a message can be generated in the CRM system and transmitted from the CRM system to the customer. In this way, once a customer has been registered with the CRM system for social network monitoring, the CRM system automatically can react to events published in the social network relevant to the customer without requiring the manual observation of the published event and subsequent manual determination of creating an action in the CRM system to respond to the event.

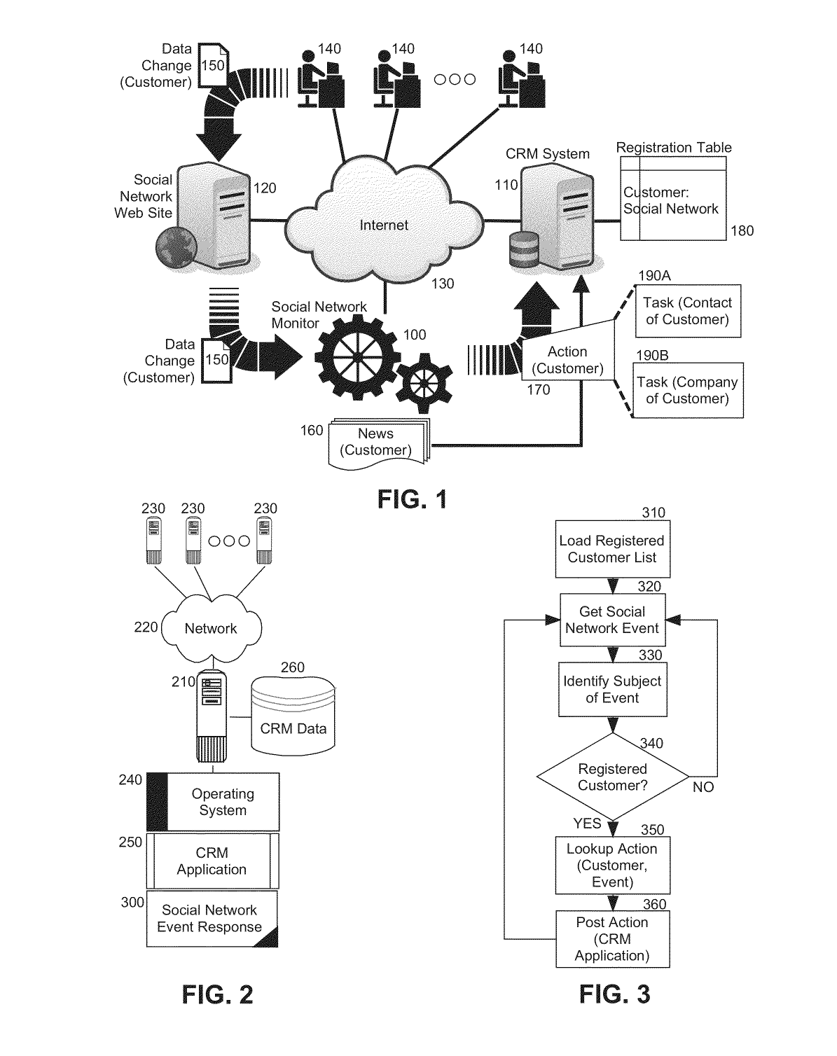

In further illustration, FIG. 1 pictorially shows a process for automated action building in a CRM system based upon social networking data changes detected in a social network. As shown in FIG. 1, a CRM system 110 can be communicatively coupled to a social networking Web site 120 over the Internet 130. Different customers 140 tracked within the CRM system 110 can be registered with the CRM system 110 in a registration table 180 for monitoring associated social networking events in the social networking Web site 120. In this regard, the different customers can be both individual contacts, companies for whom contacts work, or any combination thereof. Thereafter, data changes 150 can be detected in the social networking Web site 120 for the registered customers 140.

In this regard, data changes 150 can include profile information for the registered customers 140 that changes in social networking Web site. Additionally, data changes 150 can include changes in the profiles of co-workers of the registered customers 140 when the registered customers 140 or employed by a company. Yet further, the data changes 150 can include changes in the profiles of the company for which a registered customer 140 works. Even yet further, the data changes 150 can include changes in employees of a registered customer 140 when the registered customer 140 is a company. Finally, the data changes 150 can include changes in known business partners of the registered customer 140 when the registered customer 140 is a company.

As data changes 150 are detected by social network monitoring logic 100, an action 170 can be generated in the CRM system 110 in response to the detected data changes 150. For example, the action can include the creation of a task 190A in the CRM system 110 in respect to a contact employed by a company when the registered customer 140 is a company. In this regard, in one use case, when the data change 150 is a new employee or a new role for an existing employee of the registered customer 140, a contact can be created in the CRM system 110, or a message can be sent to the contact. Alternatively, the action can include the creation of a task 190B in the CRM system 110 in respect to a company for which the registered company 140 works. In this regard, in one use case, when the data change 150 is the announcement of new employment for the registered customer 140 by a new company, the contact information for the registered customer 140 can be changed and a task created for the contacting of the new company.

Of note, news items 160 posted on the social networking Web site 120 can be monitored by the social network monitoring logic 100. The news items can be stored in relation to one or more different registered customers 140 and rated according to relatedness to the registered customers 140. For example, news items for which a registered customer 140 is the subject can be rated higher than a news item for a co-worker of a registered customer 140 or an employee of the registered customer 140, or a known business partner of the registered customer 140, the relationships of which all can be stored in the CRM system 110 or deduced from relationship (friend or network) lists in the social networking Web site 120. Depending upon the rating of a particular news item 160, an action 170 also can be triggered in the CRM system 110 such as a display of the news item in the CRM system 110. In any event, upon selection of profile view of a registered customer 140, news items 160 for the registered customer 140 can be displayed in the CRM system 110.

The process described in connection with FIG. 1 can be implemented in a CRM data processing system. In yet further illustration, FIG. 2 schematically shows a CRM data processing system configured for automated action building based upon social networking data changes detected in a social network. The system can include a host computing system 210 that includes at least one computer with memory and at least one processor. The host computing system 210 can support the execution of an operating system 240 which in turn can host the operation of a CRM application 250 managing CRM data in a CRM data store 260. The CRM data can include, among other things, contact records for different customers.

The host computing system 210 can be coupled to different social networking systems 230 over computer communications network 220. Each of the social networking systems 230 can support a social network in which different customers tracked in the CRM application 250 can interact. Of note, a social network event response module 300 can be coupled to the CRM application 250. The social network event response module 300 can include program code enabled upon execution in the memory of the host computing system 210 to respond to events in one or more of the social networking systems 230 associated with different ones of the customers in the CRM data store 260 by creating actions in the CRM application 250 for the different ones of the customers. In this way, actions in the CRM application 250 can be automatically created for events in social networking systems 230 without requiring manual intervention on the part of an operator of the CRM application 250.

In yet further illustration of the operation of the social network event response module 300, FIG. 3 is a flow chart illustrating a process for automated action building in a CRM system based upon social networking data changes detected in a social network. The process begins in block 310 with the loading of a registered customer list for a CRM application. The registered customer list can include customers tracked in the CRM application which have been registered for social networking integration in connection with one or more social networking systems. In block 320, an event can be received in a communicatively coupled social networking system. The event can include, for example, a company change for a contact, a new position within an existing company for a contact, geographic location change for a contact, an open position for a company, a newly posted position for a company, a change in update frequency/behavior of a contact or a company, a change in private status for a contact or company, and individual-related news for a contact or company, to name only a few.

Thereafter, in block 330 a subject of the event can be identified—for example a name of a contact or company. In decision block 340, if the subject matches a registered customer in the registered customer list, the process can continue through block 350. In block 350, an action associated with the event and the registered customer can be identified, for example in a table of event response rules specifying which action in the CRM application to undertake in response to a particular event. For example, the action can include posting a task in the CRM application associated with the registered customer, or scheduling a meeting in the CRM application with the registered customer in response to a particular event being detected in the social networking system, such as the publishing of a change of position or employment by the registered customer, or the hiring of a new employee for a particular job by the registered customer. Subsequently, in block 360 the chosen action can be applied to the CRM application.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for automated action building in a customer relationship management (CRM) system based upon social networking data changes detected in a social network, the method comprising:
registering different customers in a CRM application for social network monitoring;
detecting an event for one of the registered different customers in a social networking system communicatively coupled to the CRM application over a computer communications network; and,
responding to the event by posting an action in the CRM application for the one of the registered different customers.

2. The method of claim 1, wherein the event is a profile change of the customer indicating a new position with a new.

3. The method of claim 1, wherein the event is a profile change of the customer indicating a newly hired employee for a particular position with the customer.

4. The method of claim 1, wherein the action is a task in the CRM application associated with the one of the registered customers.

5. The method of claim 1, wherein the action is a meeting scheduled in the CRM application with the one of the registered customers.

6. The method of claim 1, further comprising collecting news items for the registered different customers in different social networking systems and displaying news items for a specific one of the registered different customers responsive to displaying a profile of the specific one of the registered different customers in the CRM application.

7. The method of claim 1, further comprising collecting news items for the registered different customers in different social networking systems, rating the news items according to a relatedness between the registered different customers and the news items, and displaying only those news items for a specific one of the registered different customers of a threshold rating responsive to displaying a profile of the specific one of the registered different customers in the CRM application.

8. A customer relationship management (CRM) data processing system comprising:
a host computing system with memory and at least one processor;
a CRM application executing in the memory of the host computing system and coupled to a plurality of social networking systems over a computer communications network; and,
a social network event response module coupled to the CRM application, the module comprising program code that when executed in the memory of the host computing system is enabled to detect an event for one of different registered customers in one of the social networking systems, and to respond to the event by posting an action in the CRM application for the one of the different registered customers.

9. The system of claim 8, wherein the event is a profile change of the customer indicating a new position with a new company.

10. The system of claim 8, wherein the event is a profile change of the customer indicating a newly hired employee for a particular position with the customer.

11. The system of claim 8, wherein the action is a task in the CRM application associated with the one of the registered customers.

12. The system of claim 8, wherein the action is a meeting scheduled in the CRM application with the one of the registered customers.

13. The system of claim 8, wherein the program code of the module is further enabled to collect news items for the registered different customers in the different social networking systems and to display news items for a specific one of the different registered customers responsive to displaying a profile of the specific one of the different registered customers in the CRM application.

14. The system of claim 8, wherein the program code of the module is further enabled to collect news items for the registered different customers in the different social networking systems, to rate the news items according to a relatedness between the different registered customers and the news items, and to display only those news items for a specific one of the different registered customers of a threshold rating responsive to displaying a profile of the specific one of the different registered customers in the CRM application.

15. A computer program product for automated action building in a customer relationship management (CRM) system based upon social networking data changes detected in a social network, the computer program product comprising:
a computer readable storage medium having computer readable program code embodied therewith, the computer readable program code comprising:
computer readable program code for registering different customers in a CRM application for social network monitoring;
computer readable program code for detecting an event for one of the registered different customers in a social networking system communicatively coupled to the CRM application over a computer communications network; and,
computer readable program code for responding to the event by posting an action in the CRM application for the one of the registered different customers.

16. The computer program product of claim 15, wherein the event is a profile change of the customer indicating a new position with a new company.

17. The computer program product of claim 15, wherein the event is a profile change of the customer indicating a newly hired employee for a particular position with the customer.

18. The computer program product of claim 15, wherein the action is a task in the CRM application associated with the one of the registered customers.

19. The computer program product of claim 15, wherein the action is a meeting scheduled in the CRM application with the one of the registered customers.

20. The computer program product of claim 15, further comprising computer readable program code for collecting news items for the registered different customers in different social networking systems and displaying news items for a specific one of the registered different customers responsive to displaying a profile of the specific one of the registered different customers in the CRM application.

21. The computer program product of claim 15, further comprising computer readable program code for collecting news items for the registered different customers in different social networking systems, rating the news items according to a relatedness between the registered different customers and the news items, and displaying only those news items for a specific one of the registered different customers of a threshold rating responsive to displaying a profile of the specific one of the registered different customers in the CRM application.
